(19) United States
(12) Patent Application Publication
(10) Pub. No.: US 2006/0155624 A1
(43) Pub. Date: Jul. 13, 2006

(54) Insurance product, risk transfer product, or fidelity bond product for lost income and/or expenses due to jury duty service

(76) Inventor: Jason Peter Schwartz, Stuart, FL (US)

Correspondence Address: Jason Peter Schwartz, 1790 NW River Trail, Stuart, FL, 34994, US

(21) Appl. No.: 11/183,655

(22) Filed: Jul. 18, 2005

Related U.S. Application Data
(60) Provisional application No. 60/642,816, filed on Jan. 8, 2005.

(51) Int. Cl. G06Q 40/00

(52) U.S. Cl. 705/35

(57) ABSTRACT

An insurance, risk transfer, or fidelity bond product to replace in whole or in part lost income, productivity and/or pay for business, personnel, and personal expenses if a business or professional person, employee or key man or owner, is called to serve on jury duty.

### CROSS-REFERANCE TO RELATED APPLICATIONS

This application claims the benefit of provisional patent application Ser. No. 60/642,816 filed Jan. 8, 2005 by the present inventor.

### FEDERALLY SPONSORED RESEARCH

Not Applicable

### SEQUENCE LISTING OR PROGRAM

Not Applicable

### BACKGROUND OF THE INVENTION—FIELD OF INVENTION

This invention relates to business methods, specifically an insurance product, risk transfer product, or fidelity bond product for loss of income and expenses related to serving jury duty.

### BACKGROUND OF THE INVENTION—PRIOR ART

Individuals, companies, corporations or business entity have not had an insurance product, risk transfer product, or fidelity bond product to address income loss due to a person being called for jury duty and/or serving jury duty and the expenses related to the loss of the personnel and their work product and/or the replacement of said personnel or having their work assumed by other personnel.

### BACKGROUND OF THE INVENTION—OBJECTS AND ADVANTAGES

Accordingly, several objects and advantages of my invention are:

(a) an insurance product, risk transfer product, or fidelity bond product to replace in whole or in part lost income and/or pay for business and personnel, and personal expenses if a business or professional person, employee or key man or owner, is called to serve on jury duty;

(b) the business and personal expenses continue on, even though he or she or the business entity may not be able to produce the same income or product due to serving on jury duty;

(c) employed and self employed professionals and small business owners of all types whose businesses depend on them to personally render services need jury duty lost income protection;

(d) lost income due to jury duty service needs to be replaced in whole or in part with an insurance product income because business overhead and personal expenses continue;

(e) insurance, risk transfer, or fidelity bond coverage is needed for businesses to help cover the financial costs of lost days from work of an employee who is serving jury duty and;

(f) this financial loss could be in the form of the cost for replacement personnel or decreased business productivity from that jury-serving employee being absent;

(g) this insurance, risk transfer, or fidelity bond product can be made available as a business policy, a stand alone policy, an option or rider to a business policy, homeowners' policy or any other insurance package that makes this product available to someone or some business entity seeking this type of insurance product.

(h) the positive image and publicity this product presents to the public is tremendous as it allows citizens to more enthusiastically accept their civic responsibility to serve on a jury and;

(i) this should allow the product to be recommended and endorsed by the legal and judicial profession

Further objects and advantages of my invention will become apparent from a consideration of the ensuing description.

### SUMMARY

My invention is an insurance, risk transfer, or fidelity bond product to replace in whole or in part lost income, productivity and/or pay for business, personnel, and personal expenses if a business or professional person, employee or key man or owner, is called to serve on jury duty.

### DRAWINGS

Not Applicable

### DETAILED DESCRIPTION

Not Applicable

### SEQUENCE LISTING

Not Applicable

I claim:

1. A method for reimbursing a person's, both natural and artificial, losses due to mandatory government requirements comprising:
(a) providing a means to collect currency, chattels, or other items of value,
(b) using said currency, chattels, or other items of value to finance a reimbursement program,
(c) whereby the losses due to mandatory government requirements incurred by said person, both natural and artificial, shall be recoverable from said reimbursement program.

2. The method of claim 1 wherein said reimbursement program reimburses said person's, both natural and artificial, losses for participation in united states federal, state, or territorial jury-duty.
